(19) United States
(12) Patent Application Publication
(10) Pub. No.: US 2005/0263967 A1
(43) Pub. Date: Dec. 1, 2005

(54) BICYCLE SKI SHOE

(76) Inventors: GERARDO PICARIELLO, LYNN, MA (US); FRANK J. DIBENEDETTO, LYNN, MA (US)

Correspondence Address: FRANK J. DIBENEDETTO, 30 BONAVESTA STREET, LYNN, MA, 01905, US

(21) Appl. No.: 10/709,725

(22) Filed: May 25, 2004

(51) Int. Cl. B62K 13/00

(52) U.S. Cl. 280/7.12

(57) ABSTRACT

This invention relates to self-propelled vehicles in particular to bicycles that are equipped to travel upon loose or frozen surfaces such as snow and ice. The object to embody this invention in the nature of an attachment capable of being readily applied to Downhill Bikes, Freeride Bikes, Mountain Bikes and/or ordinary common bicycles. This invention will enable the effective propelling of the vehicle over snow and ice by the use of this invention accompanied with a common ski and manipulation of the pedals (cranks) in the usual designed manner of a bicycle. It is also proposed the enabling of this invention will require the application of the invention with a Common Ski without any change to the bicycle's designed manufactured geometry and/or material changes to the bicycle other than the removal of the front wheel.

### BACKGROUND OF INVENTION

Bicycles of various types have been used in a wide range of sports. Over the past 12 years Extreme mountain biking has grown creating new sports such as Downhill, Freeride and Jibbing. The ability to conduct these sports on snow-covered terrain is difficult due to poor wheel/surface traction. Many snow (and/or ice) conversion kits for bicycles have be designed and patented but offer a limited use when applied to there design application.

One type is intended merely for down hill travel such as are shown in U.S. Pat. Nos. 6,626,441, 4,097,055 and 4,027,891. U.S. Pat. No. 4,097,055 disclose a snow vehicle constructed of a bicycle-like frame supported on in-line front and rear skies wherein the front ski is steered by the handlebars. U.S. Pat. No. 4,027,891 discloses a conventional bicycle frame wherein both wheels have been removed and replaced with skies. While this type of snow bicycle are useful for down hill sledding, particularly in a ski lift accessed slope area, they are of little use.

Self-propelled snow vehicles also are known. However, attempts to convert a bicycle to a self-propelled snow bicycle by installing a front ski in place of the front wheel have heretofore not been successful. One reason for this lack of success is that simply replacing the front wheel with a ski effectively changes the designed geometry of the designed bicycle the ski is attached to. Another problem is the attachment or mounting of a single type of front ski to the bicycle. This limits the type of ski to be used over variable snow and/or ice covered terrain.

Most snow bike designs do not allow the bicycle to be pedaled uphill or downhill. Various bicycle ski conversions that allow the bicycle to be pedaled are to involved and complex for practical use by extreme mountain bikers. This invention would allow easy conversion of a standard mountain bike to allow the capability to be pedaled across snow-covered and/or ice covered terrain.

Major drawbacks of these self-propelled snow vehicles are the complication of the drive modifications and the expense of such extensive modifications to the drive system. Such complicated drive systems do not lend themselves to installation by the recreational bicycle owner and are impractical both from the standpoints of complexity, weight added to the bicycle and cost.

Related Sports

Mountain biking, off-road bicycling and/or bicycling in and around nature have become a popular sport. Such sports provide unique challenging riding conditions including steep downhill descents, sharp curves and rough terrain. Other unique challenges for riders in the wilderness or natural environments are obstacles such as large rocks, fallen trees and an array of natural obstructions. These natural conditions provide additional enjoyment and challenge to the cycling experience.

Some efforts have been made to continue mountain biking in the winter. Bicycles converted to snow bikes of specific design only allow for modest downhill sledding. The cost and relative complexity of converting ones bicycle/bike is an undertaking not widely accepted.

### SUMMARY OF INVENTION

In accordance with the present invention, the Bicycle Ski Shoe may be used with a Downhill Bike, Freeride Bike, Mountain Bike and/or ordinary common bicycles. Such bikes usually include a frame including generally upright head and seat tubes connected by a generally horizontal top tube.

A Bicycle Ski Shoe consists of an assembly including (1), but not limited to a short ski, pivot control arm, a support structure and/or frame and mounting brackets. This apparatus allows for converting a standard mountain bicycle (bike) into a human powered snow bike allowing the user to pedal the bike through the snow. A standard mountain bike consist of the following (but not limited to) components, front wheel (10), front suspension forks (11), rear wheel (12), frame (13), pedals, cranks and drive chain (14), handle bars (15) mechanical/hydraulic disk brakes (16) and a seat (17). To convert a standard mountain bike into a snow bike utilizing the bicycle ski shoe (1), the front wheel (10) is removed and replaced with the bicycle ski shoe (1). The standard mountain bike is ready for use on the snow and is powered through the normal design operations of a standard bicycle.

### BRIEF DESCRIPTION OF DRAWINGS

The Bicycle Ski Shoe consists of the following components. A manufactured ski binding, structural frame unit, gravity lifting assembly (GLA), clamping mechanism and adjustable axle/hub assembly.

FIG. 1 outlines the layout of a general Mountain Bike and/or ordinary common bicycle.

FIG. 2 outlines the attachment of the Bicycle Ski Shoe (1) illustrating its replacement of the bicycle's front wheel (10).

FIG. 3 outlines the layout of a general Downhill Bike and/or full suspension bicycle used for extreme rough terrain.

FIG. 4 outlines the attachment of the Bicycle Ski Shoe (1) illustrating its replacement of the bicycle's front wheel (10).

FIG. 5 outlines a detail list of components used in the assembly of the present invention (Bicycle Ski Shoe).

FIG. 6 outlines the ability of the present inventory to detach the ski assembly through the use of a standard ski bindings referenced in U.S. Pat. Nos. 6,471,235 and 6,454,291.

FIG. 7 illustrates the ability of the present invention to pivot through the Gravity Lift Assembly (102, 103).

FIG. 8 illustrates the geometry of a Downhill Bike, Freeride Bike, Mountain Bike and/or ordinary common bicycle.

FIG. 9 illustrates the geometry of a Downhill Bike, Freeride Bike, Mountain Bike and/or ordinary common bicycle with the utilization of the present invention herein.

### DETAILED DESCRIPTION

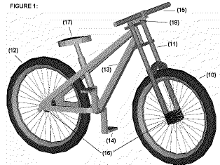

Referring to the drawings, FIG. 1 outlines the general components of a bicycle. This drawing provides a description of each component but is not limited to the following. A general bicycle may consist of a front wheel (10) range from 20-inch, 24-inch and/or 26-inch diameter in size. The bicycle also consists of a rear wheel (12) range from 20-inch, 24-inch and/or 26-inch diameter in size. The rear wheel (12) contains a sprocket set that allow a chain to connect to the pedal/crank assembly (14) allowing forward motion during normal design operation. Items 12 and 14 are mounted onto a bicycle frame (13) allowing for structural support. A seat and/or saddle (17) is mounted onto the frame allowing the user to sit in an upright and/or forward leaning position on the bicycle. Item 10 is mounted onto a front fork (11) that may be ridge in structure and/or allow for suspension travel. This suspension may range from 3-inches to 12 inches of travel but is not limited to this range. Both items 10 and 11 are connected to the frame (13) through a headset (18). Mechanical caliper, hydraulic caliper and/or disk brakes (16) are attached to both front (10) and rear (12) wheels respectively. Controls for these brakes are mounted on a handlebar (15) that allows the user to steer the bicycle during forward and/or backward motion.

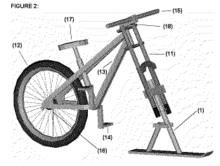

Referring to the drawings, FIG. 2 outlines the bicycle in FIG. 1 with the attached Bicycle Ski Shoe (1). This drawing provides a description of each component but is not limited to the following. The front wheel (10) has been replaced with the present invention (1), a Bicycle Ski Shoe. The present invention (1) will replace a front wheel (10) range from 20-inch, 24-inch and/or 26-inch diameter in size. The bicycle also consists of a rear wheel (12) range from 20-inch, 24-inch and/or 26-inch diameter in size. The rear wheel (12) contains a sprocket set that allow a chain to connect to the pedal/crank assembly (14) allowing forward motion during normal design operation. Items 12 and 14 are mounted onto a bicycle frame (13) allowing for structural support. A seat and/or saddle (17) is mounted onto the frame allowing the user to sit in an upright and/or forward leaning position on the bicycle. Item 10 is mounted onto a front fork (11) that may be ridge in structure and/or allow for suspension travel. This suspension may range from 3-inches to 12 inches of travel but is not limited to this range. Both items 10 and 11 are connected to the frame (13) through a headset (18). Mechanical caliper, hydraulic caliper and/or disk brakes (16) are attached to both front (10) and rear (12) wheels respectively. Controls for these brakes are mounted on a handlebar (15) that allows the user to steer the bicycle during forward and/or backward motion.

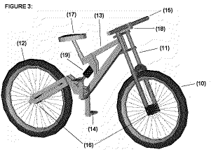

Referring to the drawings, FIG. 3 outlines the general components of a full suspension bicycle. This drawing provides a description of each component but is not limited to the following. A general full suspension bicycle may consist of a front wheel (10) range from 20-inch, 24-inch and/or 26-inch diameter in size. The full suspension bicycle also consists of a rear wheel (12) range from 20-inch, 24-inch and/or 26-inch diameter in size. The rear wheel (12) contains a sprocket set that allow a chain to connect to the pedal/crank assembly (14) allowing forward motion during normal design operation. Items 12 and 14 are mounted onto a two piece bicycle frame (13) allowing for structural support connected by a single and/or multipliable pivot points. Each piece of the bicycle frame (13) allows linear movement between them with the used of a suspension shock (19). This suspension shock may range from 3-inches to 12 inches of travel but is not limited to this range. A seat and/or saddle (17) is mounted onto the frame allowing the user to sit in an upright and/or forward leaning position on the bicycle. Item 10 is mounted onto a front fork (11) that may be ridge in structure and/or allow for suspension travel. This suspension may range from 3-inches to 12 inches of travel but is not limited to this range. Both items 10 and 11 are connected to the frame (13) through a headset (18). Mechanical caliper, hydraulic caliper and/or disk brakes (16) are attached to both front (10) and rear (12) wheels respectively. Controls for these brakes are mounted on a handlebar (15) that allows the user to steer the bicycle during forward and/or backward motion.

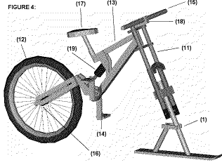

Referring to the drawings, FIG. 4 outlines the bicycle in FIG. 3 with the attached Bicycle Ski Shoe (1). This drawing provides a description of each component but is not limited to the following. The front wheel (10) has been replaced with the present invention (1), a Bicycle Ski Shoe. The present invention (1) will replace a front wheel (10) range from 20-inch, 24-inch and/or 26-inch diameter in size. The full suspension bicycle also consists of a rear wheel (12) range from 20-inch, 24-inch and/or 26-inch diameter in size. The rear wheel (12) contains a sprocket set that allow a chain to connect to the pedal/crank assembly (14) allowing forward motion during normal design operation. Items 12 and 14 are mounted onto a two piece bicycle frame (13) allowing for structural support connected by a single and/or multipliable pivot points. Each piece of the bicycle frame (13) allows linear movement between them with the used of a suspension shock (19). This suspension shock may range from 3-inches to 12 inches of travel but is not limited to this range. A seat and/or saddle (17) is mounted onto the frame allowing the user to sit in an upright and/or forward leaning position on the bicycle. Item 10 is mounted onto a front fork (11) that may be ridge in structure and/or allow for suspension travel. This suspension may range from 3-inches to 12 inches of travel but is not limited to this range. Both items 10 and 11 are connected to the frame (13) through a headset (18). Mechanical caliper, hydraulic caliper and/or disk brakes (16) are attached to both front (10) and rear (12) wheels respectively. Controls for these brakes are mounted on a handlebar (15) that allows the user to steer the bicycle during forward and/or backward motion.

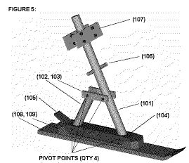

Referring to the drawings, FIG. 5 outlines the assembly of the present invention (1). The present invention (1) consist for the following components. A main frame structure (101) that supports and carries the loads when outfitted to a bicycle. This frame (101) provides the body for each of the present inventions components to be assembled to. The frame (101) is mounted to a ski binding (104) that is modified to accept a bearing cartridge to allow perpendicular movement to the frame (101) member. Parallel to the frame (101), the bottom section of the Gravity Lift Assembly (102, 103) is connected to the ski binding (104) through the uses of a bearing cartridge allowing for vertical movement. The modified ski binding (104) is equipped with a binding release assembly (105) similar to standard release bindings referenced in U.S. Pat. Nos. 6,471,235 and 6,454,291. The top section of the GLA (102, 103) is connected to the frame (101) through the use of two bearing cartridges allowing for vertical pivoting movement. An axle carrier assembly (106) is attached to the frame (101). The axle carrier assembly (106) provides the point of attachment to the bicycle front fork (11). The axle carrier assembly (106) is designed to utilize the same axle provided with the bicycle's front wheel (10). Above the axle carrier assembly (106) and connected to the frame (101) is the fork clamp assembly (107). The fork clamp assembly (107) is adjustable to accept both single and triple crown bicycle forks that are either ridge or allow for suspension travel. The fork clamp assembly (107) adjust by locking bolt mounted through the clamp assembly. The fork clamp assembly (107) is clamped onto the bicycle's front fork (11) as illustrated in FIGS. 2 and 4. The binding receiver (108) and ski (109) are standard products reference in U.S. Pat. Nos. 6,471,235 and 6,454,291. The binding receiver (108) and ski (109) are assembled together per the manufacturer specifications under the referenced United States Patents herein.

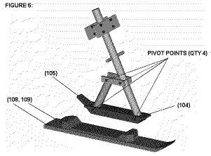

Referring to the drawings, FIG. 6 outl ines the ability to detach the binding receiver (108) and the ski (109) from the ski binding (104) through the use of the binding release assembly (105). Both the ski binding (104) and binding release assembly (105) operate under the same designed mechanics referenced in U.S. Pat. Nos. 6,471,235 and 6,454,291. Modification of the ski binding (104) to accept both frame (101) and GLA (102, 103) components through the used of bearing cartridges. Both binding receiver (108) and the ski (109) are standard products referenced in U.S. Pat. Nos. 6,471,235 and 6,454,291. The binding release assembly (105) allows the present invention the ability to change the binding receiver (108) and/or ski (109) components to a bigger and/or wider and/or longer and/or shorter component.

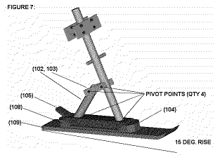

Referring to the drawings, FIG. 7 illustrates the ability for the present invention to pivot the ski binding (104), the binding release assembly (105), the binding receiver (108) and the ski (109) through the use of the GLA (102, 103) components. The GLA (102, 103) components comprise of four pivot points through the use of bearing cartridges. The GLA (102, 103) allows the above referenced components to pivot vertically when the present invention (1) is lifted off and/or has no contact with snow covered terrain. The GLA (102, 103) also allows movement of the above referenced components to pivot vertically during movement across rough terrain.

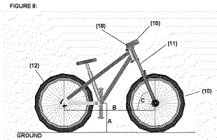

Referring to the drawings, FIG. 8 illustrates the design geometry of a Downhill Bike, Freeride Bike, Mountain Bike and/or ordinary common bicycle. Bicycle designed geometry specifications are provided by the manufacturer of the bicycle. Point A illustrates the distance between the ground and the bottom of the bicycle as it relates to the pedal crank assembly (14). Point B illustrates the distance between the front wheel (10) and rear wheel (12) as it relates to wheelbase. Point C illustrates the angle of the front fork (11), handlebar (15) and headset (18) as it related to Point B elevated parallel to the referenced ground.

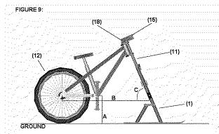

Referring to the drawings, FIG. 9 illustrates the design geometry of a Downhill Bike, Freeride Bike, Mountain Bike and/or ordinary common bicycle utilizing the present invention herein. Point A illustrates the distance between the ground and the bottom of the bicycle as it relates to the pedal crank assembly (14). Point B illustrates the distance between the present invention (1) and rear wheel (12) as it relates to wheelbase. Point C illustrates the angle of the front fork (11), handlebar (15) and headset (18) as it related to Point B elevated parallel to the referenced ground. In both FIGS. 8 and 9, Points A, B and C are the same distance in respect to the designed geometry of the bicycle. No change in the bicycle's manufactured geometry as it relates to Points A, B and C.

1. The present invention will provide a kit that allows for simple modification of a conventional bicycle for converting the bicycle into a self-propelled snow bicycle.

2. Another object of the present invention is to provide a self-propelled snow bicycle without having to modify the conventional chain and rear wheel drive system.

3. Another object of the present invention is to provide a self-propelled snow bicycle without changing and/or modifying the designed manufactured geometry of the bicycle.

4. Another object of the present invention is to provide no change in regards to the distance the front axle (11) to respect to the ground. This distance would be the same regardless the front wheel (10) and/or the Bicycle Ski Shoe (1) were assembled onto the front axle (11).

5. Another object of the present invention is to provide the ability for the user to change the front SKI with shorter, longer and/or wider (fatter) skis through use of the standard ski binding.

6. Another object of the present invention is to provide natural pivoting of the Bicycle Ski Shoe during movement over rough and/or hilly snow covered terrain.

7. Another object of the present invention is to provide a natural upward pivot of the Bicycle Ski Shoe through the used of the GLA (102, 103). This allows the front (nose) of the ski to point up at greater then 15 degrees if the front of the bicycle was to leave contact with the snow/ice covered terrain. Example would be jumping the converted bicycle off a man made snow jump that both skiers and snowboards alike use on mountain trails.
